(19) United States
(12) Patent Application Publication
(10) Pub. No.: US 2005/0115927 A1
(43) Pub. Date: Jun. 2, 2005

(54) Vacuum switch

(75) Inventor: Kazuhiko Kagawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/820,784

(22) Filed: Apr. 9, 2004

(30) Foreign Application Priority Data
Dec. 2, 2003 (JP) P2003-403638

(51) Int. Cl. H01H 33/66

(52) U.S. Cl. 218/118

(57) ABSTRACT

A vacuum switch is provided with a vacuum valve 1 including a stationary-side terminal conductor 3 and a moving-side terminal conductor 16. In the vacuum switch, a radiator 29 provided with a cover 37 making open a side face of a plurality of fin-shaped protrusions 36 extending outwardly from the terminal conductor 3, 16 and surrounding an outer periphery, is fixed to the terminal conductor 3, 16. Furthermore, the plurality of fins 43 including a cover 42 making a side face open and surrounding an outer periphery is integrally molded on the terminal conductor 3, 16. As a result, a vacuum switch is capable of making smaller an air clearance between the radiator and a peripheral housing.

### BACKGROUND OF THE INVENTION

1. Field of the Invention

The present invention relates to an electric power vacuum switch such as circuit breaker or conductor and, more particularly, relates to a radiating structure of a terminal conductor of the vacuum switch.

2. Description of the Related Art

Generally in a conventional vacuum switch, a fin-shaped radiator including a protrusion on an outer periphery is mounted on a terminal conductor thereof, thereby making a radiating area larger and suppressing a heat generation at the time of being conducted. Such an invention is proposed, for example, in the Japanese Patent Publication (unexamined) No. 40019/1999.

In the conventional vacuum switch, since a fin shape of a radiator forms protrusion outwardly, the protrusion, being a live part at a high voltage, is in the sate likely to discharge due to electrostatic focusing action. Normally, a vacuum switch is used in an electric power circuit of AC three-phase type, and three-phases of terminal conductors and radiators having an analogous configuration are located in the proximity. In order for the protrusion of a radiator to possess a predetermined satisfactory insulating performance between the phases, as well as between the phases and an earth electric potential, air clearance for the purpose of insulation becomes larger between one radiator and another, as well as between the radiators and a peripheral housing. As a result, a problem exists in that a vacuum switch comes to be larger.

### SUMMARY OF THE INVENTION

The present invention was made to solve the above-discussed problem, and has an object of obtaining a vacuum switch in which an electrostatic focusing occurs relatively less at a radiator mounted on a terminal conductor thereby enabling to make smaller an air clearance between the radiator and a peripheral member.

A vacuum switch according to the invention is provided with a vacuum valve including a stationary-side terminal conductor and a moving-side terminal conductor, and the vacuum switch is further provided with a radiator that is fixed to the mentioned terminal conductor and includes a cover surrounding an outer periphery of a fin-shaped protrusion extending outwardly from the mentioned terminal conductor.

In the vacuum switch of the invention, it is possible to make smaller an air clearance between the radiator and a peripheral member thereby downsizing the vacuum switch.

Further, in the vacuum switch according to the invention, the plurality of fins provided with a cover making open the side face of the fins and surrounding the outer periphery thereof are integrally molded on the mentioned terminal conductor.

In the vacuum switch of the invention, since the fins provided with a cover are integrally molded on the terminal conductor, it is possible to reduce number of parts, make assembling easier, and improve effect of radiation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a top view showing a vacuum switch according to a first preferred embodiment of the present invention.

FIG. 2 is a cross sectional view taken along the line A-A of FIG. 1.

FIG. 3 is a perspective view of a radiator for use in the vacuum switch in FIG. 1.

FIG. 4 is a cross sectional view taken along the line B-B of FIG. 3.

FIG. 5 is a perspective view showing a terminal conductor for use in a second embodiment.

FIG. 6 is a top view showing a vacuum switch according to the second embodiment on which the stationary-side terminal conductor is mounted.

FIG. 7 is a perspective view showing a terminal conductor for use in a third embodiment.

FIG. 8 is a top view showing a vacuum switch according to a fourth embodiment.

FIG. 9 is a perspective view of a radiator for use in the fourth embodiment.

### DETAILED DESCRIPTION OF THE INVENTION

### Embodiment 1

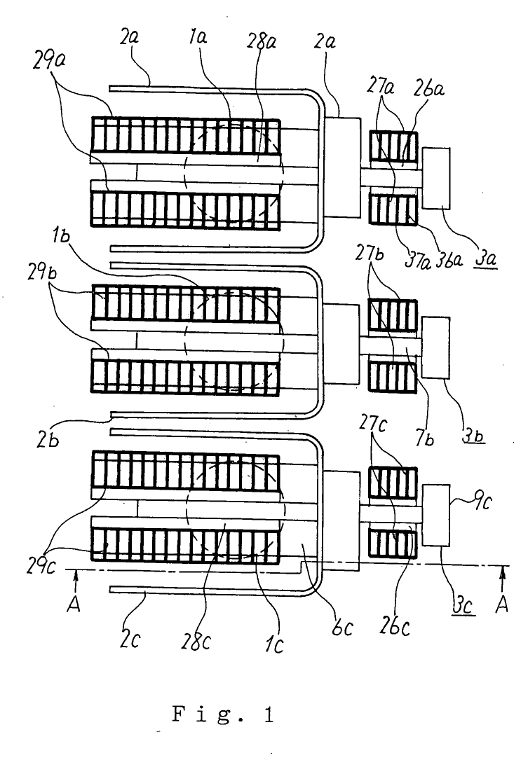

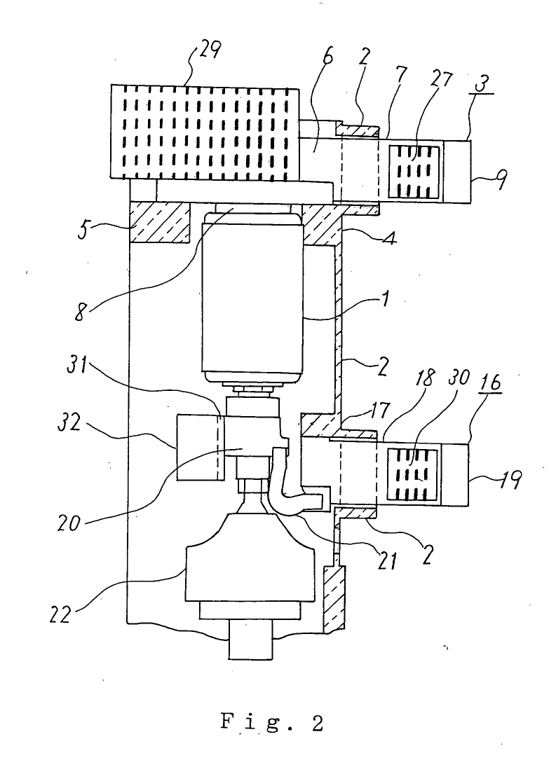

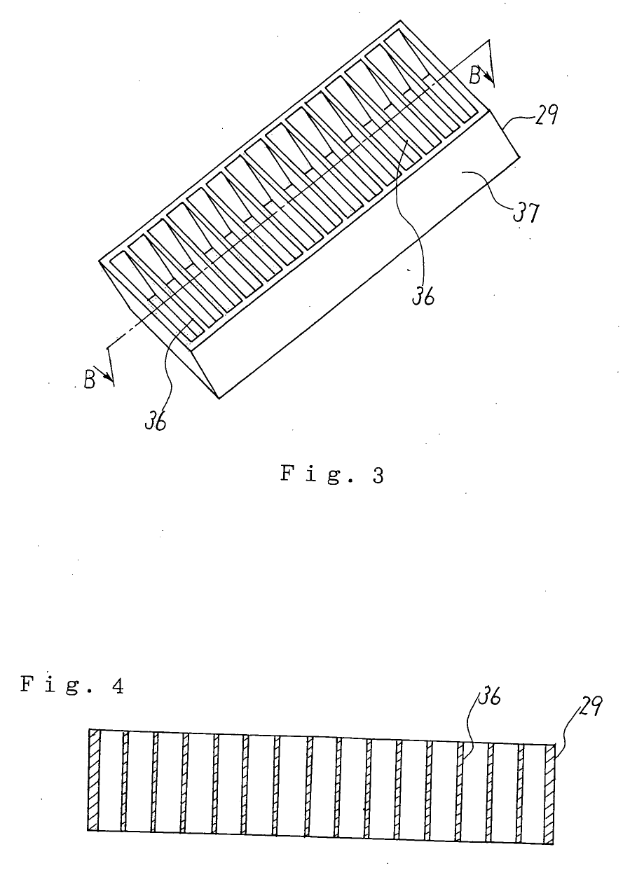

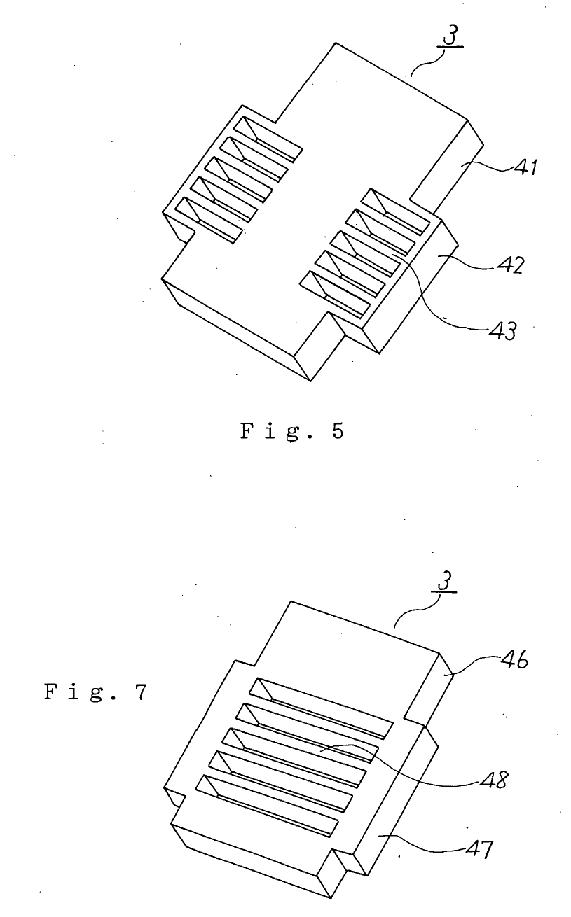

FIG. 1 is a top view showing a vacuum switch according to a first preferred embodiment of the invention, FIG. 2 is a cross sectional view taken along the line A-A of FIG. 1, FIG. 3 is a perspective view of a radiator for use in FIG. 1, and FIG. 4 is a cross sectional view taken along the line B-B of FIG. 3. It is to be noted that, in a three-phase vacuum switch, three pieces of one-phase vacuum switches having an analogous configuration are located in the proximity. The reference numerals are indicated with a, b, c in the drawings is to make a distinction between the phases. Referring to the drawings, a vacuum valve 1 forming a contact is housed in an insulating frame 2. A stationary-side terminal conductor 3 of the vacuum valve 1 extends between a front mounting part 4 and a rear mounting part 5 of the insulating frame 2, and fixedly mounted onto each mounting part 4, 5. The stationary-side terminal conductor 3 consists of a T-shaped portion 6 of substantially T shape in cross section and which extends between the front mounting part 4 and the rear mounting part 5, and a vertical strip portion 7 leading outwardly from the insulating frame 2. An end face of a stationary electrode plate 8 of the vacuum valve 1 is in contact with a lower surface of the T-shaped portion 6, and both faces are fixed to each other. A main circuit junction of the stationary-side terminal conductor 3 is provided at an end of the strip portion leading outwardly.

A moving-side terminal conductor 16 of the vacuum valve 1 includes a strip portion 18 one end of which is fixedly mounted onto a front mounting part 17 of the insulating frame 2. A main circuit junction 19 of the moving-side terminal conductor 16 is provided at the other end of the strip portion 18. A moving-side terminal fitting 20 is fixed to a moving portion of the vacuum valve 1 and forms a part of the moving-side terminal conductor 16. A flexible conductor 21 is connected to the moving-side terminal fitting 20 at one end, and is connected to the strip portion 18 at the other end. An insulating rod 22 is connected to a moving portion of the vacuum valve 1 at one end, and is connected to an operating mechanism (not shown) of this vacuum valve 1 at the other end.

At the strip portion 7 of the stationary-side terminal conductor 3, a radiator-mounting base 26 is integrally formed on both sides of the strip portion 7, and a stationary-side radiator 27 is bonded or secured with a bolt to each base 26. At a vertical part of the T-shaped portion 6 of the stationary-side terminal conductor 3, a radiator-mounting base 28 is integrally formed on both sides of the vertical part. Further, a stationary-side radiator 29 as shown in FIGS. 3 and 4 is bonded or secured with a bolt to each base 28. Like manner, at the strip portion 18 of the moving-side terminal conductor 16, a radiator-mounting base (not shown) is integrally formed on both sides of the strip portion 18, and a moving-side radiator 30 is bonded or secured with a bolt to each base. A moving-side radiator 32 is fixed to the moving-side terminal fitting 20 via the mentioned radiator-mounting base 31.

Each radiator 27, 29, 30, 32 is provided with a plurality of fin-shaped protrusions 36 (see FIGS. 3 and 4) extending outwardly from the stationary-side terminal conductor 3 or the moving-side terminal conductor 16 respectively secured via a mounting base. Further, a cover 37 surrounding the protrusion 36 is provided on an outer periphery of the protrusion 36. Each radiator 27, 29, 30, 32 is molded of copper, aluminum or the like of a high thermal conductivity along with the fin-shaped protrusion 36 and the cover 37. As shown with FIGS. 3 and 4, in each radiator 27, 29, 30, 32, a cover 37 surrounding a plurality of fin-shaped protrusions 36 is provided on the outer periphery of the protrusions 36. However, side faces of each radiator 27, 29, 30, 32 are open to efficiently perform radiation of heat. In the vacuum switch of such a constitution, since the cover 37 is applied to ends of the fin-shaped protrusion 36 of the radiator 27, 29, 30, 32 and side faces of the fin-shaped protrusion 36 are open, not only radiation of heat is efficiently performed, but the electrostatic focusing is relieved thereby making discharge less likely to occur. Consequently, it is possible to make smaller an air clearance between the three-phases of radiators, and between the radiator and the peripheral housing thereby enabling to downsize a vacuum switch.

### Embodiment 2

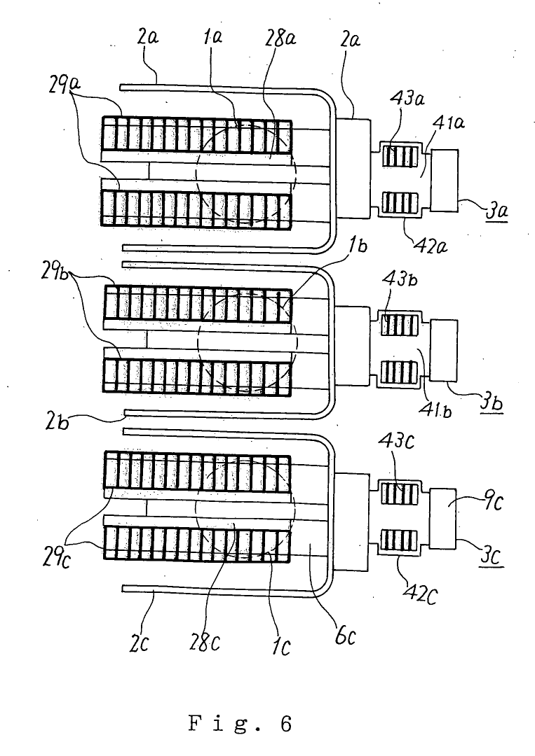

FIG. 5 is a perspective view showing a terminal conductor for use in a second embodiment of the invention. In the case of the foregoing first embodiment, the radiator 27 is fixed to the vertically located strip portion 7 of the stationary-side terminal conductor 3, whereas in this second embodiment, a horizontally located strip portion 41 is used instead of the vertically located strip portion 7. As shown in FIG. 5, by integrally molding a plurality of fins 43, of which side face is open and which includes a cover 42 surrounding the outer periphery, on an outer periphery of the horizontally located strip portion 41 of the stationary-side terminal conductor 3, number of parts is reduced and assembling becomes easy. FIG. 6 is a top view of a vacuum switch on which the stationary-side terminal conductor according to this second embodiment is mounted. Since a heat resistance between the strip portion 41 of the stationary-side terminal conductor 3 and the fin 43 is reduced, the effect of radiation of heat is improved. Furthermore, application of such construction is not restricted to the stationary-side terminal conductor 3, and the moving-side terminal conductor 16 may also be preferably constructed likewise.

In the drawings, like reference numerals indicate the same or like parts.

### Embodiment 3

FIG. 7 is a perspective view showing a terminal conductor for use in a third embodiment of the invention. As shown in FIG. 7, by integrally molding a fin 48 of which side face is open and which includes a cover 47 surrounding an outer periphery in an internal part of a horizontally located strip portion 46 of the stationary-side terminal conductor 3, the same effect as the second embodiment can be assured. Since a conductive current-carrying part having a large cross section is located at an outer peripheral portion, the terminal conductor possesses a skin effect that an AC current is likely to flow through a surface portion of the conductor. Further, such a terminal conductor allows lower decrease in high flexure rigidity as compared with flexure rigidity of a conductor having the same outside dimension without the fin 48. Furthermore, in the terminal conductor according to this third embodiment, it is unnecessary to make an outer dimension of a conductor rather large as compared with a terminal conductor without the fin 48, and as a result it is possible to make the stationary-side terminal conductor 46 lighter. In addition, application of such construction is not restricted to the stationary-side terminal conductor 3, and the moving-side terminal conductor 16 may also be constructed likewise.

### Embodiment 4

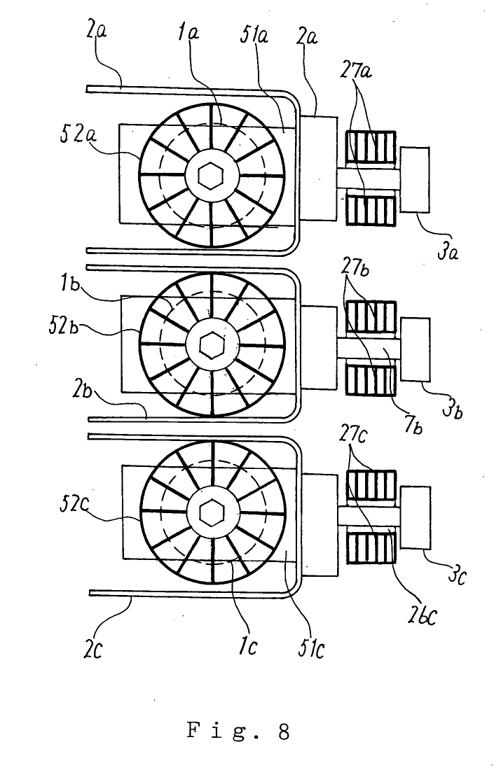

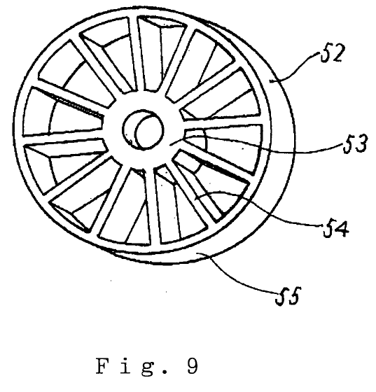

FIG. 8 is a top view showing a vacuum switch according to a fourth embodiment. FIG. 9 is a perspective view of a radiator for use in this fourth embodiment. As a part of a stationary-side terminal conductor 3 according to this fourth embodiment, instead of the T-shaped portion 6 according to the foregoing first embodiment, a horizontal located strip portion 51 is employed. On a top surface of this strip portion 51, an annular radiator 52 is secured with a bolt or adhesive. In the annular radiator 52, a plurality of fin-shaped protrusions 54 are radially provided from a central part 53, and there is provided an annular cover 55 making a side face of the fin-shaped protrusions open and surrounding an outer periphery. The annular radiator 52 is formed of copper, aluminum or the like of a high thermal conductivity. In the vacuum switch of such a constitution, since ends of the fin-shaped protrusion 54 of the annular radiator 52 is applied with the cover 55 and side faces of the fin-shaped protrusion 54 are open, satisfactory radiation of heat is achieved and the electrostatic focusing is relieved, thereby making the discharge less likely to occur. Consequently, it is possible to make smaller an air clearance between the three-phases of radiators and between the radiator and the peripheral housing, thereby enabling to downsize a vacuum switch.

While the presently preferred embodiments of the present invention have been shown and described. It is to be understood that these disclosures are for the purpose of illustration and that various changes and modifications may be made without departing from the scope of the invention as set forth in the appended claims.

1. A vacuum switch having three phases, each phase of said vacuum switch including a vacuum valve with a stationary-side terminal conductor and a moving-side terminal conductor, said vacuum switch comprising:
radiators for each phase, fixed to at least one of said stationary-side terminal conductor and said moving-side terminal conductor, said radiators having a plurality of fin-shaped protrusions extending outwardly from at least one of said stationary-side terminal conductor and said moving-side terminal conductor; and
a cover provided for at least one of said radiators, which relieves electrostatic focusing between said radiators for each phase, said cover leaving open a side of the plurality of fin-shaped protrusions and surrounding an outer periphery of the plurality of fin-shaped protrusions.

2. The vacuum switch according to claim 1, wherein the plurality of fin-shaped protrusions provided with the cover are integrally molded on said at least one of said stationary-side terminal conductor and said moving-side terminal conductor for said each phase.

3. The vacuum switch according to claim 1, wherein the plurality of fin-shaped protrusions for said each phase are arranged parallel to each other in a lengthwise direction of said radiator.
